(19) United States
(12) Patent Application Publication
(10) Pub. No.: US 2013/0044835 A1
(43) Pub. Date: Feb. 21, 2013

(54) Data blocks encoding and transmission over a diversity communication network

(71) Applicants: JULIEN SEVIN, Saint Aubin du Cormier (FR); MOUNIR ACHIR, Chantepie (FR); PHILIPPE LE BARS, Thorigne-Fouillard (FR)

(72) Inventors: JULIEN SEVIN, Saint Aubin du Cormier (FR); MOUNIR ACHIR, Chantepie (FR); PHILIPPE LE BARS, Thorigne-Fouillard (FR)

(73) Assignee: CANON KABUSHIKI KAISHA, Tokyo (JP)

(21) Appl. No.: 13/572,331

(22) Filed: Aug. 10, 2012

(30) Foreign Application Priority Data
Aug. 16, 2011 (GB) 1114089.4

(51) Int. Cl. H04B 7/06

(52) U.S. Cl. 375/295

(57) ABSTRACT

The invention relates to a method of transmitting a data unit over a plurality of transmission paths of a wireless communication system that is adapted to minimize bandwidth usage and energy consumption while maintaining transmission robustness. A method of transmitting K data blocks of a data unit comprises the steps of encoding the data unit into an encoded data unit comprising N encoded blocks, with N>K, using an error correction code having a minimum distance d; and transmitting the N blocks of the encoded data unit over a set of N_{P} transmission paths, where N_{P}≧2, wherein at least N−d+1 different encoded blocks are transmitted over at least one subset of N_{P}−M transmission paths, where M is representative of the number of transmission paths that can be blocked without preventing the receiver from recovering the K data blocks of the data unit.

### CROSS-REFERENCE TO RELATED APPLICATIONS

This application claims the benefit under 35 U.S.C. §119(a)-(d) of United Kingdom Patent Application No. 1114089.4, filed on Aug. 16, 2011 and entitled “Data blocks encoding and transmission over a diversity communication network”.

The above cited patent application is incorporated herein by reference in its entirety.

### BACKGROUND OF THE INVENTION

1. Field of the Invention

This invention relates to the field of wireless communication of information and more particularly to wireless communication of uncompressed video information.

2. Description of the Background Art

It is known in the prior art to use spatial diversity to bring robustness when communicating information wirelessly between a transmitter and a receiver. Spatial diversity is brought by the use a plurality of transmission paths for transmitting a same information in a wireless communication system. If a transmission fails through one transmission path because of an obstacle for example, information is likely to reach the receiver through an alternative transmission path.

However duplicating information transmission over a plurality of transmission paths consumes communication network bandwidth and communication devices energy as transmitting and receiving antennas need to cover spatially the different transmission paths during emission and reception.

The present invention has been devised to address at least the foregoing concern. More specifically, an object of the present invention is to minimize bandwidth usage and energy consumption while maintaining robustness as desired during information transmission in a wireless system applying spatial diversity.

### SUMMARY OF THE INVENTION

To this end, the present invention provides according to a first aspect a device for transmitting a data unit of K data blocks over a plurality of transmission paths of a wireless communication system, comprising:

an encoder for encoding the data unit into an encoded data unit comprising N encoded blocks, where N>K, using an error correction code having a minimum distance d; and

a wireless transmitter for transmitting the N encoded blocks of the encoded data unit over a set of N_{P} transmission paths, where N_{P}≧2, wherein the wireless transmitter is controlled to transmit at least N−d+1 different encoded blocks over at least one subset of N_{P}−M transmission paths, where M is a positive integer smaller than N.

Such a device allows sending an amount of data that is sufficient for a receiver to recover the original data unit even if signal emission over M transmission paths is blocked by obstacles. The necessary resources like emission power for ensuring the transmission of the data unit are therefore reduced.

According to a preferred implementation, the transmission module is configured to transmit the at least N−d+1 different encoded blocks over any subset of N_{P}−M transmission paths. This makes the transmission of the data unit successful even if any M transmission paths among the N_{P} transmission paths are blocked.

In one implementation, the error correction code is a systematic code causing the N encoded blocks of the encoded data unit to comprise the K data blocks of the data unit and N−K parity blocks generated from the encoding of the data unit. The recovery of the data blocks at the receiving side is thus easier as non lost data blocks can be retrieved directly without decoding.

In one implementation, the number K of data blocks forming the data unit is chosen to be equal to the number N_{P} of transmission paths and wherein the transmission module is further configured to transmit different data blocks over different transmission paths of the set of N_{P} transmission paths and to transmit one given parity block over all the N_{P} transmission paths. This optimizes the use of the plurality of transmission paths and the correction capacity of the error correction code.

In one implementation, the transmission module is configured to transmit the K data blocks using a directional beam antenna and the parity block using a multi-beam or wide beam antenna. This minimizes the energy required for emitting the plurality of data and parity blocks and still ensures a successful recovery of the data unit at the reception side.

In a preferred implementation, the error correction code is a maximum separable code with a minimum distance d=N−K+1, the number of different encoded blocks to be transmitted over the at least one subset of N_{P}−M transmission paths being at least equal to K. This allows to have an efficient coding that reduces the necessary amount of redundant information for a given correction capacity of the code.

In one implementation, a plurality of communication channels are defined in the wireless network for transporting the encoded blocks to be transmitted, different communication channels correspond to different transmission time slots and/or different transmission paths. This creates diversity when transmitting the encoded blocks which leads to a more robust transmission and higher correction capacity as lost blocks may be distributed over different encoded data units.

According to a second aspect, the present invention provides a method of transmitting a data unit of K data blocks over a plurality of transmission paths of a wireless communication system, comprising the steps of:

encoding the data unit into an encoded data unit comprising N encoded blocks, with N>K, using an error correction code having a minimum distance d; and

transmitting the N blocks of the encoded data unit over a set of N_{P} transmission paths, where N_{P}≧2, wherein at least N−d+1 different encoded blocks are transmitted over at least one subset of N_{P}−M transmission paths where M is a positive integer smaller than N_{P}.

According to a third aspect, the present invention provides a wireless communication system comprising:

an encoder for encoding the data unit into an encoded data unit comprising N encoded blocks, with N>K, using an error correction code having a minimum distance d;

a wireless transmitter for transmitting the N encoded blocks of the encoded data unit over a set of N_{P} transmission paths, where N_{P}≧2, wherein the wireless transmitter is configured to transmit at least N−d+1 different encoded blocks over at least one subset of N_{P}−M transmission paths where M is a positive integer smaller than N_{P};

a wireless receiver configured to receive the encoded blocks of the encoded data unit via the set of at least two transmission paths N_{P}; and

a decoder for decoding a unit formed by the received encoded blocks to recover the original data unit.

The present invention also extends to programs which, when run on a computer or processor, cause the computer or processor to carry out the method described above or which, when loaded into a programmable device, cause that device to become the device described above. The program may be provided by itself, or carried by a carrier medium. The carrier medium may be a storage or recording medium, or it may be a transmission medium such as a signal. A program embodying the present invention may be transitory or non-transitory.

The particular features and advantages of the method, the wireless communication system and the program being similar to those of the device for transmitting a data unit of K data blocks, they are not repeated here.

### BRIEF DESCRIPTION OF THE DRAWINGS

FIG. 1 depicts for illustrative purposes a wireless communication network employing spatial diversity.

FIG. 2 illustrates a functional block diagram of a communication device implementing both a transmitter and a receiver.

FIG. 3a depicts an example of an antenna having a single narrow main beam.

FIG. 3b depicts an example of an antenna having a single wide main beam.

FIG. 4a is a schematic configuration illustrating the functional blocks for emitting radio signals through a multi-beam antenna array according to one implementation of the invention.

FIG. 4b is a schematic configuration illustrating the functional blocks for receiving radio signals through a multi-beam antenna array according to one implementation of the invention.

FIG. 5 depicts a time division multiplexing (TDM) used for sharing access to the radio medium.

FIG. 6 is a flowchart showing how data blocks of a video stream are transmitted over a plurality of communication channels according to an embodiment of the invention.

FIG. 7 shows the encoding of a video data unit using a systematic block code.

FIG. 8 shows one encoding scheme technique used for encoding data blocks.

### DETAILED DESCRIPTION OF THE INVENTION

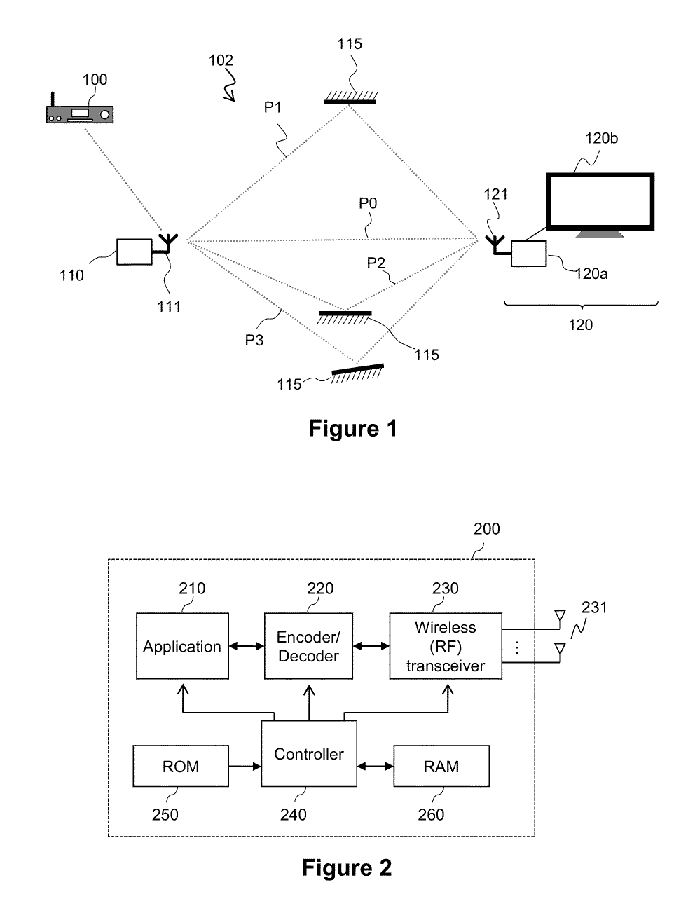

FIG. 1 depicts for illustrative purposes a wireless communication network 102 employing spatial diversity. Spatial diversity relies on the use of a plurality of transmission paths between communicating devices. Typically, wireless communication network 102 operates in the unlicensed 60 GHz frequency band (millimeter waves) for providing enough bandwidth capacity to support the transport of uncompressed HD video content.

Network 102 comprises a first device 110 embodying a transmitter (Tx) and a second device 120 embodying a receiver (Rx). In this particular example, the second device 120 is composed of a communication device 120a connected to the wireless network and of a display device 120b connected to the communication device 120a for rendering the received data content, e.g. displaying the video. It is to be noted that the first device 110 may also represent a relay device, the originator of the data being then represented by another device 100 belonging to the communication network. It is common to have a meshed network comprising relay devices for relaying data between different devices to cope with the short range of the millimeter waves.

A signal emitted by antenna 111 of first device 110 may reach antenna 121 of second device 120 through a line-of-sight (LOS) transmission path P0 if it is not blocked by any obstacle. In addition, the signal may be reflected by objects 115 which may cause the establishment of a plurality of non line-of-sight (NLOS) transmission paths P1, P2 and P3.

In a variant implementation of the invention, each of the first device 110 and second device 120 embody both a transmitter and a receiver to establish a bi-directional communication. This allow for example to insert feedback control information in the data flow transmitted in the reverse direction from the second device to the first device. In this implementation variant, the two devices share a same hardware platform. An apparatus based on this hardware platform is referred to generically hereinafter as communication device.

FIG. 2 illustrates a functional block diagram of a communication device 200 that implements both a transmitter Tx and a receiver Rx. Communication device 200 includes a wireless transceiver (transmitter-receiver) 230, an encoder/decoder unit 220 and an application unit 210 to which is directed or from which is obtained the exchanged video data, each of which is also coupled to a controller 240. The wireless transceiver is typically a radio frequency (RF) transceiver circuitry that is connected to an antenna 231. The communication device furthermore includes a ROM 250 and a RAM 260 for data and program storage.

Typically, controller 240 is embodied as a central processing unit (CPU), which operates in accordance with a program stored in the ROM 250. The controller provides a work area in the RAM 260, and accesses and uses the work area during operation. Controller 240 will normally control overall data processing over the received or to be transmitted data, whereas signal processing operations associated with communication functions are typically performed in RF transceiver circuitry 230.

RF transceiver 230 performs functions such as modulation/demodulation, signal-to-noise (SNR) estimation and antenna control. This latter is detailed later on with regards to FIGS. 4a and 4b.

Transmission paths P0, P1, P2, P3 may be created by different radiation patterns/configurations of antenna 111 of first device 110 and detected by different receiving patterns/configurations of antenna 121 of second device 120.

A narrow beam antenna (directional antenna) can be used at the first device 110 when emitting a signal and/or at the second device 120 when receiving a signal. Steering an antenna to a given orientation corresponds to configuring its parameters (for example the weighting coefficients associated with the elements of an antenna array) such that the radiation of the signal, in case of emission, or the antenna sensitivity, in case of reception, is accentuated in that given direction relatively to other directions.

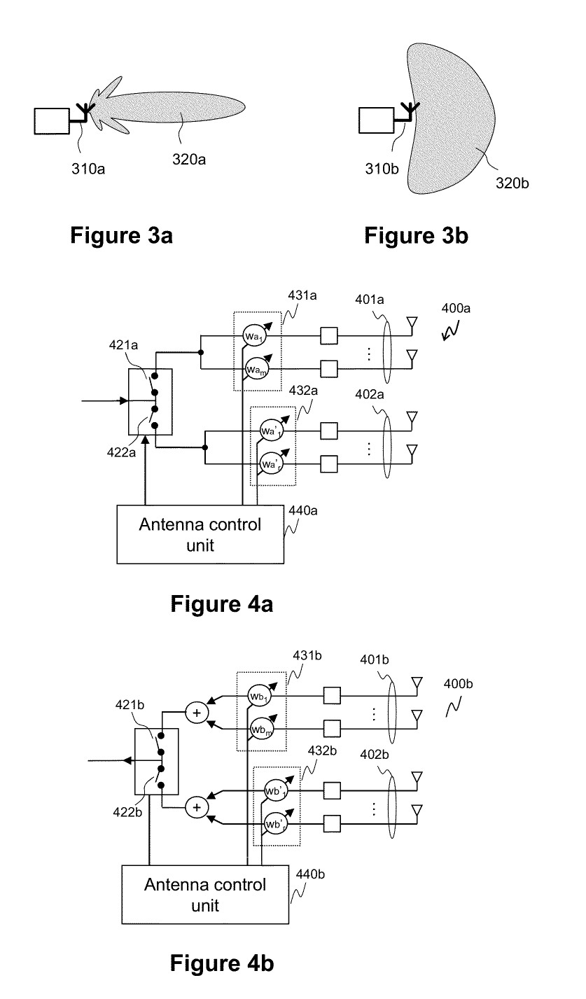

FIG. 3a depicts an example of an antenna 310a having a single narrow main beam 320a (angle equals 5°, measured at −3 dBi from the maximum, where “dBi” represents a measure of antenna gain relatively to an isotropic antenna). The main beam gain is relatively high, for example 25 dBi. The antenna has thus different gain characteristics at different reception angles. A maximum gain is obtained in the direction of the main beam.

In a situation where both first and second devices implement directional antennas, the beams of both antennas 111 and 121 have to be steered to an orientation that corresponds to one given transmission path. This latter could be either a LOS transmission path (P0) or a NLOS transmission path (P1, P2, P3) as depicted in FIG. 1.

Alternatively, a wide or near omni-directional antenna can be used at the first device 110 when emitting a signal and/or at the second device 120 when receiving the signal. When a near omni-directional or a wide beam antenna is used, a transmission towards or reception from a plurality of transmission paths can be effected simultaneously.

FIG. 3b depicts an example of an antenna 310b having a single wide main beam 320b (angle equals 210°). The main beam gain is thus relatively small, approximately 4 dBi.

A wide beam or near omni-directional antenna can be implemented as a dedicated antenna. Alternatively, an array antenna comprising a plurality of antenna elements dedicated for directional transmission can be reused by activating a single antenna element among the array of antenna elements.

Simultaneous emission/reception of signals over/from a plurality of transmission paths can also be implemented by using a multi-beam antenna array as it will be depicted hereinafter with regards to FIGS. 4a and 4b.

FIG. 4a is a schematic configuration illustrating the functional blocks for emitting radio signals through a multi-beam antenna array 400a according to one implementation of the invention.

The illustrated two-beam antenna array is formed by a first group of antenna elements 401a and a second group of antenna elements 402a. Each group of antenna elements can be separately controlled by an antenna control unit 440a for a selective emission of signals in a particular direction.

For the first group of antenna elements 401a, the selective emission is accomplished by selecting the first group by means of the selector 421a and setting the weighting coefficients (wₐ₁, . . . , wₐₘ) 431a to be applied to the signal to be sent towards the different elements of the first group. Antenna gain is thus increased in a first desired direction. For the second group of antenna elements 402a, the selective emission is accomplished by selecting the second group by means of the selector 422a and setting the weighting coefficients (w′ₐ₁, . . . , w′ₐᵣ) 432a to be applied to the signal to be sent towards the different elements of the second group. Antenna gain is thus increased in a second desired direction.

More generally, a multi-beam antenna array can formed by two or more groups of antenna elements.

FIG. 4b is a schematic configuration illustrating the functional blocks for receiving radio signals through a multi-beam antenna array 400b according to one implementation of the invention.

The illustrated two-beam antenna array is formed by at least a first group of antenna elements 401b and a second group of antenna elements 402b. Each group of antenna elements can be separately controlled by an antenna control unit 440b for a selective reception of signals in a particular direction. For the first group of antenna elements 401b, the selective reception is accomplished by setting weighting coefficients (w_{b1}, . . . , w_{bm}) 431b to be applied to each signal path from the different elements of the first group and selecting signal reception from the first group by means of the selector 421b. Antenna gain is thus increased in a first desired direction. For the second group of antenna elements 402b, the selective reception is accomplished by setting weighting coefficients (w_{b1}, . . . , w_{br}) 432b to be applied to each signal path from the different elements of the second group and selecting signal reception from the second group by means of the selector 422b. Antenna gain is thus increased in a second desired direction.

More generally, a multi-beam antenna array can formed by two or more groups of antenna elements.

A multi-beam antenna array can thus be implemented by controlling separately the at least two groups of antenna elements, i.e. antenna elements 401a, 402a for transmitting antenna 400a, and antenna elements 401b, 402b for receiving antenna 400b.

It is to be noted that a single-beam antenna array can also be implemented with these same antenna architectures either by selecting only one group of antenna elements or by controlling jointly the at least two groups of antenna elements as a single set of antenna elements so that to form one main beam.

As pointed out above, the use of narrow beam antennas either at the emitting or receiving sides makes it possible to increase the antenna gains. This feature is advantageously used in an embodiment of the present invention to reduce the emission power, and thus to save energy, when using a narrow beam antenna (for a given distance between the transmitter and the receiver) instead of keeping the transmission power calibrated for a wide beam antenna.

Using a multi-beam antenna array makes it possible to transmit towards only the required transmission paths and thus energy is saved compared to a wide beam emission that radiates in a greater number of directions.

The antenna control units 440a and 440b are considered to be part of the RF transceiver 230 and are controlled more globally by the controller 240 of the communication device embodying the corresponding antennas.

The setting up of a plurality of transmission paths is advantageously used in the present invention to create a plurality of communication channels with spatial diversity between the transmitter Tx and the receiver Rx.

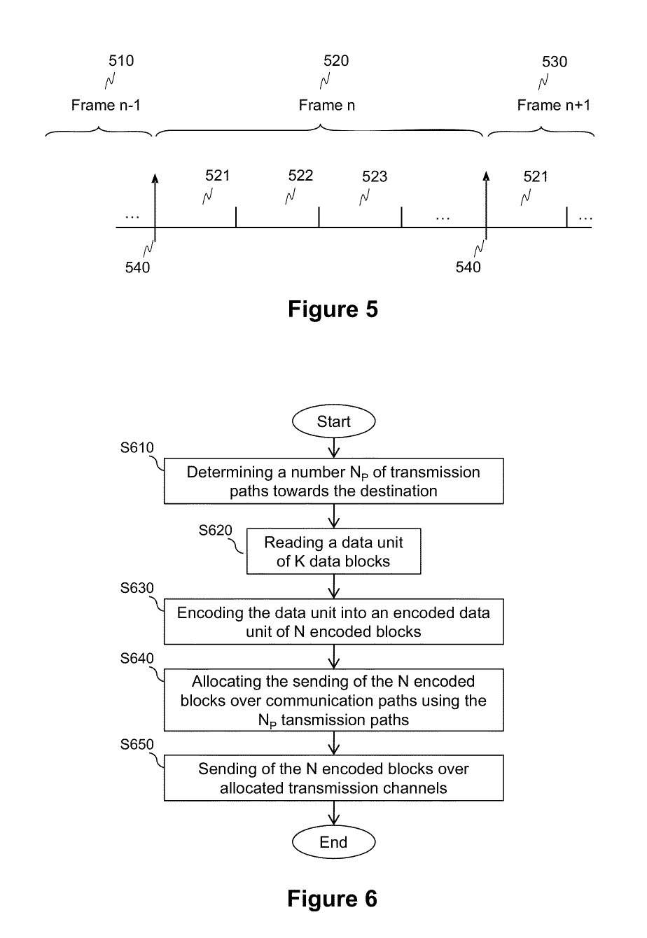

In one embodiment of the invention, time division multiplexing (TDM) is used for sharing access to the radio medium as depicted in FIG. 5. A plurality of time slots 521, 522, 523, . . . are provided periodically in every frame 510, 520, 530. The start of a frame is signaled by means of a beacon signal 540 consisting of a predetermined pattern of data symbols. A communication channel is created by associating one given time slot of a series of frames, e.g. 521, with one given transmission path. Sending data over said communication channel corresponds to configuring transmitter antenna 111 to radiate in at least the direction of the given transmission path and emitting radio signals representative of said data during the given time slot 521 in the series of frames. Receiving data from said communication channel corresponds to configuring receiver antenna 121 to be sensitive in at least the direction of the given transmission path and receiving radio signals representative of said data during the same given time slot in the series of frames. Consequently, different communication channels correspond to different transmission time slots and/or different transmission paths. Both spatial and temporal diversities are thus ensured when transmitting over the different communication channels.

In another embodiment of the invention, a frequency division multiple access (FDMA) scheme may be used for sharing the radio medium. A communication channel is then created by associating one given carrier frequency with one given transmission path. Sending data over said communication channel corresponds to configuring transmitter antenna 111 to radiate in at least the direction of the given transmission path and emitting radio signals representative of said data by modulating the given carrier frequency. Receiving data from said communication channel corresponds to configuring receiver antenna 121 to be sensitive in at least the direction of the given transmission path and receiving signals representative of said data by demodulating the given carrier frequency. Consequently, different communication channels correspond to different carrier frequencies and/or different transmission paths. Both spatial and spectral diversities are thus ensured when transmitting over the different communication channels.

In a further embodiment, the two above embodiments are combined. A communication channel is created by associating one given transmission path with both one given time slot of a series of frames and one given carrier frequency. Consequently, different communication channels correspond to different carrier frequencies, different transmission time slots and/or different transmission paths. Spatial, temporal and spectral diversities are thus ensured when transmitting over the different communication channels.

As previously described, the controller 240 operates in accordance with a program stored in the ROM 250. FIG. 6 is a flowchart of a segment of the program stored in the ROM 250 of first device 110 and that shows how data blocks of the video stream are transmitted over the plurality of communication channels according to an embodiment of the invention.

With reference to FIG. 6, a first step S610 in the program segment determines a number N_{P} of transmission paths towards the second device 120 representing the destination of the data stream. The number N_{P} represents preferably the total number of available paths, e.g. N_{P}=4 in the example of the wireless communication network 102 of FIG. 1. In a variant, a subset of the total number of available paths is chosen including the most reliable transmission paths.

A transmission path is considered as available if the SNR of radio packets received through this path from the transmitting device is above a predetermined threshold which allows a correct decoding of data. Determining of the most reliable paths can be performed by comparing their associated SNR. The higher is the SNR, the more reliable the transmission path is. The SNR can be determined using the SNR estimation function of the RF transceiver 230 of the second device 120 which is communicated back to the first device 110 using a feedback channel.

A second step S620 reads K data blocks of the video stream to form a data unit. The number K is chosen preferably equal to a multiple of N.

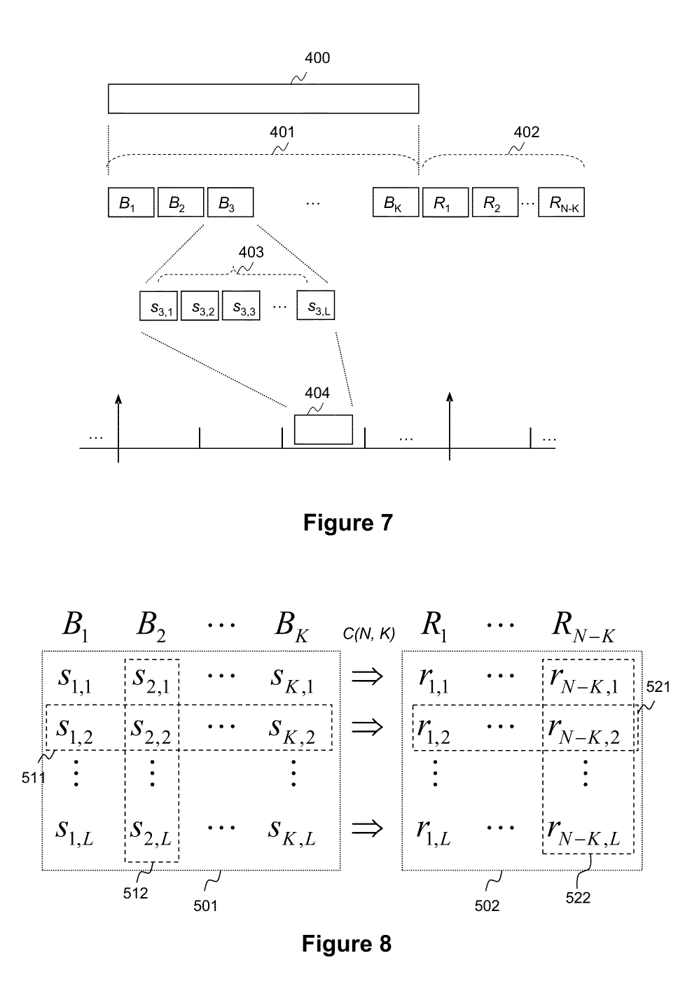

Step S630 encodes the formed data unit into an encoded data unit of N encoded blocks using an error correction code C(n, k) with minimum distance d, where n and k are parameters of the code. Details on the implementation of the encoding of the K data blocks into the N encoded blocks are provided hereinafter with reference to FIG. 7.

Step S640 allocates the sending of the N encoded blocks over communication channels using the N_{P} transmission paths so that at least N−d+1 different encoded blocks are transmitted over at least one subset of N_{P}−M transmission paths, where M is a positive integer smaller than N_{P}. M is representative of the number of transmission paths that can be blocked without preventing the receiver from recovering the K data blocks of the data unit.

The sending is then effected at step S650 by controlling the wireless transceiver 230. The N encoded blocks are sent over the allocated communication channels.

As indicated in step S630 above, an encoder is provided for encoding a data unit formed by a group of K data blocks into an encoded data unit comprising N encoded blocks, with N>K, using an error correction code. If the code is systematic, the encoded data unit comprises the K data blocks left unchanged to which are appended N−K parity blocks, also called redundancy blocks. Encoded blocks are generated from the data blocks. Example on how encoded blocks are generated is provided hereinafter.

FIG. 7 shows the encoding of a video data unit 400 using a systematic block code. Reference 401 indicates K data blocks (Bᵢ) forming the data unit 400 and reference 402 refers to the N−K parity or redundancy blocks (Rᵢ) generated by the error correction code. All blocks are assumed to have a fixed size of L symbols as for example symbols s_{3,1} to S_{3,L} 403 of data block B₃. This is not however a requirement, since padding data can be used to obtain fixed size blocks.

Encoded (data or parity) blocks are destined to be individually transmitted in radio packets over the radio medium. For example data block B₃ is shown to be transmitted in a radio packet 404 during one time slot of a TDM scheme.

Typically, a block code C takes a word of k information symbols and transforms it into a codeword of n symbols, where n>k and n−k representing the amount of redundancy added by the code. The symbols are elements of an “alphabet” of finite size. Typically, symbols are binary elements (bits) belonging the alphabet {0, 1} of size 2 or bytes (8 bits) belonging to the alphabet {0, . . . , 255} of size 2⁸=256.

The correction capacity of a code is defined by its minimum distance d and depends on the rate of the code (k/n) and how the parity symbols are generated from the information symbols. The greater the minimum distance, the higher is the correction capacity of the code. The highest correction capacity is obtained when d=n−k+1. Codes providing such minimum distance are called maximum distance separable (MDS) codes. A Reed-Solomon code is an example of an MDS code.

Different techniques can be used to generate N−K parity blocks from a set of K data blocks using a code C(n, k).

A first technique is to encode the data blocks at a symbol level by choosing the parameters k=K*L and n=N*L for the code C(n, k). This technique requires the use of a long length code if the number K of blocks to encode is high. For example, if the size of a block is 512 bytes (a byte representing a symbol), a code C(3072, 2048) would be needed in order to generate two parity blocks (N−K=2) from four data blocks (K=4).

A second technique consists in increasing the symbol size (number of binary elements) to reduce the number of symbols per block, the upper limit being equal to the size of one block. This technique may lead to a tremendously large alphabet making the encoding and decoding processes complex (a symbol of size 2 bytes corresponds to an alphabet of size 2¹⁶=65536).

In a preferred embodiment, a third technique is used for the encoding of data blocks. The encoding scheme principle based on this technique is depicted in FIG. 8.

The K data blocks Bᵢ are organized into a matrix 501 where each column 512 corresponds to a data block Bᵢ, with 1≦i≦K, and where each line 511 is formed by a plurality of symbols taken at a given position j, with 1≦j≦L, from every data block Bᵢ. Each line of K symbols 511 is encoded with a code C(N, K) to generate N−K parity symbols 521. The parity symbols r_{i,j} are also organized into a matrix 502 where each column 522 forms a parity block Rᵢ, with 1≦i≦N−K. This technique allows the use of conventional codes to encode a plurality of data blocks of arbitrary size by applying the code C(n=N, k=K) L times, where the number K of data blocks per data unit 400 equates the number of symbols per information word to be encoded.

All the above described techniques are also applicable to a non systematic error correction code. In such a case, the encoder delivers N encoded blocks forming the encoded data unit. The matrix 502 would then extend to include N columns with L symbols each.

In one implementation example, the block code is a Reed-Solomon code RS(224, 216) with 8-bit symbols. This code is capable of correcting up to 8 missing bytes (errors in known positions in the codeword) or locate and correct up to 4 byte errors (or combination of both). Considering the third technique of encoding data blocks described above, the correcting capability of RS(224, 216) when translated to the block level result in that up to 8 missing (data or parity) blocks can be corrected in an encoded data unit of 224 blocks, or up to 4 erroneous blocks can be located and corrected.

It is to be noted that from a given code, like RS(224, 216), it is possible to derive a variety of codes (n′, k′) with n′≦n and k′≦k by applying shortening and puncturing techniques known by persons skilled in the art.

In a preferred implementation of the transmission chain, encoded blocks of the encoded data unit are individually protected by an error detection code, e.g. by adding a checksum, before their inclusion in the transporting radio packets for transmission. At the receiver side, presence of errors in a block can be detected and the block discarded. Consequently, all the symbols contained in the discarded block are marked as erasures in the different lines of data or parity symbols, 511 or 521 respectively. This advantageously allows to use the maximum correcting capacity of the error correction code C as localizing erroneous symbols is no longer needed, i.e. 8 missing blocks can be corrected in case of the RS(224, 216).

In another implementation example, the block code is a bitwise exclusive OR code XOR(K+1, K) which generates one parity symbol by performing a bitwise exclusive OR to K information symbols. A parity block can then be obtained using the third technique described above. In an equivalent way, the bitwise exclusive OR can be applied directly to the K data blocks to generate one parity block as the coding operation is done at a bit level.

XOR is simple code used when only one parity block needs to be generated. It has a minimum distance d=2. It allows to recover one missing symbol or block at the decoding side. Typically, if code XOR(3, 2) is used, the data unit contains two data blocks B₁ and B₂ and the generated redundancy block is R₁=B₁⊕B₂. R₁ can recover any one of the two data blocks B₁ and B₂, thus if B₁ is missing for example, it can be simply recovered as B₁=R₁⊕B₂.

According to the preferred implementation of the transmission chain and similarly to the RS code above, data and parity blocks are further encoded by means of an inner error detection code, e.g. by adding a checksum, to detect corrupted blocks.

Let's describe now different allocation scheme examples of N encoded blocks over the transmission paths N_{P} corresponding to the execution of step S640 of the segment of program corresponding to FIG. 6.

First Allocation Example: N=3, K=2, N_{P}=2, M=1, d=2

A first allocation example involves defining two transmission paths (N_{P}=2) and four communication channels corresponding to the couples (transmission path 1, timeslot 1), (transmission path 2, timeslot 2), (transmission path 1, timeslot 3) and (transmission path 2, timeslot 3). Transmission paths 1 and 2 are chosen among the available paths P0 to P3 of the wireless communication network of FIG. 1 for example. The chosen encoding is a (systematic) XOR operation with K=2, N=3, i.e. XOR(3, 2).

According to this first allocation example, data blocks B₁ and B₂ and the generated redundancy block R₁=B₁⊕B₂ are transmitted over the three communication channels as depicted in the following table.

| C. | Time | Time | Time | Time | Time | Time |
|---|---|---|---|---|---|---|
| Channels | slot 1 | slot 2 | slot 3 | slot 4 | slot 5 | slot 6 |
| Tr. path 1 | B₁ | | R₁ | | | |
| Tr. path 2 | | B₂ | R₁ | | | |

This allocation makes the transmission robust against one broken transmission path (M=1). Two different blocks (corresponding to N−d+1) are transmitted in this example over all subsets of one transmission path, i.e. over transmission path 1 and transmission path 2 as summarized in the following table.

| Subsets of one | Transmitted packets | Total number of |
|---|---|---|
| transmission path | over each subset | transmitted packets |
| {Tr. path 1} | B₁, R₁ | 2 |
| {Tr. path 2} | B₂, R₁ | 2 |

Considering this allocation scheme, transmission of both data blocks B₁ and B₂ is performed using narrow beam antennas and transmission of the redundancy block R₁ is performed using either a wide beam antenna or a multi-beam antenna array with two simultaneous narrow beams directed towards the transmission paths 1 and 2 as described with regards to FIGS. 4a and 4b. This advantageously brings a reduction in power consumption compared to a wide emission of all blocks while maintaining at the same time the desired robustness level (M=1) and a limited number of used time slots as the whole data unit of two data blocks is transmitted into three time slots. Reduction in the number of time slots saves bandwidth.

Second Allocation Example: N=4, K=3, N_{P}=3, M=1, d=2

A second allocation example is a variation of the first example where the size of the data block is chosen equal to three and three transmission paths are used. A code XOR(4,3) is chosen as an example where R₁=B₁⊕B₂⊕B₃. Similarly to the first example, a robustness level of M=1 is also desired.

| C. | Time | Time | Time | Time | Time | Time |
|---|---|---|---|---|---|---|
| channels | slot 1 | slot 2 | slot 3 | slot 4 | slot 5 | slot 6 |
| Tr. path 1 | B₁ | | | R₁ | | |
| Tr. path 2 | | B₂ | | R₁ | | |
| Tr. path 3 | | | B₃ | R₁ | | |

Three different blocks (corresponding to N−d+1) are transmitted in this example over all subsets of two transmission paths (remaining paths after one broken link) as summarized in the following table.

| Subsets of two | Transmitted packets | Total number of |
|---|---|---|
| transmission paths | over each subset | transmitted packets |
| {Tr. path 2, Tr. path 3} | B₂, B₃, R₁ | 3 |
| {Tr. path 1, Tr. path 3} | B₁, B₃, R₁ | 3 |
| {Tr. path 1, Tr. path 2} | B₁, B₂, R₁ | 3 |

Transmission of all data blocks B₁, B₂ and B₃ is performed using narrow beam antennas. The transmission of the redundancy block R₁ is performed using either a wide or multi-beam antenna. Good energy saving is achieved as the increase in power consumption for sending one redundancy block over a wide or multi-beam antenna is compensated by the use of that redundancy block in different transmission paths for recovering a lost data block.

Third Allocation Example: N=4, K=3, N_{P}=3, M=1, d=2

A third allocation example is a variation of the second example that shows a non-symmetrical allocation of blocks over the available transmission paths.

| C. | Time | Time | Time | Time | Time | Time |
|---|---|---|---|---|---|---|
| channels | slot 1 | slot 2 | slot 3 | slot 4 | slot 5 | slot 6 |
| Tr. path 1 | B₁ | | | R₁ | | |
| Tr. path 2 | | B₂ | | | | |
| Tr. path 3 | | | B₃ | | | |

Particularly, we consider that N−d+1=3 different blocks are not transmitted over all subsets of N_{P}−M=2 transmission paths, but are transmitted over only two of them. These two subsets correspond to a first subset containing transmission paths 1 and 2 and a second subset containing transmission paths 1 and 3. The 3 different blocks transmitted over the first subset are then B₁, B₂ and R₁ and the 3 different blocks transmitted over the second subset being then B₁, B₃ and R₁ as depicted in the table below.

| Subsets of two | Transmitted packets | Total number of |
|---|---|---|
| transmission paths | over each subset | transmitted packets |
| {Tr. path 2, Tr. path 3} | B₂, B₃ | 2 |
| {Tr. path 1, Tr. path 3} | B₁, B₃, R₁ | 3 |
| {Tr. path 1, Tr. path 2} | B₁, B₂, R₁ | 3 |

All data and redundancy blocks can be transmitted using narrow beam antennas to reduce transmission power. This non-symmetrical allocation scheme is relevant when the different transmission paths are not equally reliable. In the above example, transmission path 1 is assumed to be enough reliable, for example because it's unlikely to be blocked considering the positioning of the communication devices and the environment where the network operates. Thus, if transmission path 2 is blocked there are still 3 different blocks B₁, B₃ and R₁ received, and if transmission path 3 is blocked there are still 3 different blocks B₁, B₂ and R₁ received. These three different blocks in each situation are enough to recover the original three data blocks B₁, B₂ and B₃.

This non-symmetrical allocation scheme is advantageous because it optimizes furthermore the resources as the power consumption (only narrow beams used) with a minimum number of time slots.

In the following examples we use a coding that generates more than one redundancy block based on RS codes.

Fourth Allocation Example: N=6, K=4, N_{P}=2, M=1, d=3

A fourth example involves using two transmission paths (N_{P}=2) and an RS(6, 4) code.

| C. | Time | Time | Time | Time | Time | Time |
|---|---|---|---|---|---|---|
| channels | slot 1 | slot 2 | slot 3 | slot 4 | slot 5 | slot 6 |
| Tr. path 1 | B₁ | | B₂ | | R₁ | R₂ |
| Tr. path 2 | | B3 | | B₄ | R₁ | R₂ |

The minimum distance of this code is 6-4+1=3. Thus N−d+1=4 different blocks are transmitted over any transmission path as shown in the table below.

| Subsets of one | Transmitted packets | Total number of |
|---|---|---|
| transmission path | over each subset | transmitted packets |
| {Tr. path 1} | B₁, B₂, R₁, R₂ | 4 |
| {Tr. path 2} | B₃, B₄, R₁, R₂ | 4 |

Fifth Allocation Example: N=6, K=4, N_{P}=3, M=1 & M=2, d=3

A fifth allocation example involves using three transmission paths (N_{P}=3) and with the same RS(6, 4) code.

| C. | Time | Time | Time | Time | Time | Time |
|---|---|---|---|---|---|---|
| channels | slot 1 | slot 2 | slot 3 | slot 4 | slot 5 | slot 6 |
| Tr. path 1 | B₁ | | | | R₁ | R₂ |
| Tr. path 2 | | B₂ | | | R₁ | R₂ |
| Tr. path 3 | | | B₃ | B₄ | R₁ | R₂ |

The obtained system having the allocation scheme shown in the above table is robust against the blocking of any one transmission path (M=1). Indeed, we have at least N−d+1=4 different blocks transmitted over any subset of N_{P}−M=2 transmission paths.

| Subsets of two | Transmitted packets | Total number of |
|---|---|---|
| transmission paths | over each subset | transmitted packets |
| {Tr. path 2, Tr. path 3} | B₂, B₃, B₄, R₁, R₂ | 5 |
| {Tr. path 1, Tr. path 3} | B₁, B₃, B₄, R₁, R₂ | 5 |
| {Tr. path 1, Tr. path 2} | B₁, B₂, R₁, R₂ | 4 |

The obtained system is furthermore robust against the simultaneous blocking of transmission paths 1 and 2 (M=2) as 4 different blocks are transmitted over the subset of N_{P}−M=1 comprising the single transmission path 3 (non-symmetrical allocation for M=2).

| Subsets of one | Transmitted packets | Total number of |
|---|---|---|
| transmission path | over each subset | transmitted packets |
| {Tr. path 3} | B₃, B₄, R₁, R₂ | 4 |

Sixth Allocation Example: N=5, K=3, N_{P}=3, M=2, d=3

A sixth allocation example involves using three transmission paths (N_{P}=3) and with a RS(5, 3) code.

| C. | Time | Time | Time | Time | Time | Time |
|---|---|---|---|---|---|---|
| channels | slot 1 | slot 2 | slot 3 | slot 4 | slot 5 | slot 6 |
| Tr. path 1 | B₁ | | | R₁ | R₂ | |
| Tr. path 2 | | B₂ | | R₁ | R₂ | |
| Tr. path 3 | | | B₃ | R₁ | R₂ | |

This allocation ensures a robust transmission against two broken transmission paths (M=2). Three different blocks (corresponding to N−d+1=5−3+1) are transmitted in this example over all subsets of one transmission path, i.e. over transmission paths 1, 2 and 3 as shown in the table below.

| Subsets of one | Transmitted packets | Total number of |
|---|---|---|
| transmission path | over each subset | transmitted packets |
| {Tr. path 2} | B₂, R₁, R₂ | 3 |
| {Tr. path 3} | B₃, R₁, R₂ | 3 |
| {Tr. path 1} | B₁, R₁, R₂ | 3 |

1. A device, comprising:
a wireless transmitter that transmits first data via a first transmission path of a first direction, second data via a second transmission path of second direction different from the first direction, and parity data via the first direction and the second direction, wherein the parity data is generated from the first data and the second data; and
a direction controller that controls a transmission direction of the first data, the second data and parity data.

2. A device according to claim 1, wherein the direction controller is configured to transmit the first data and the second data using a directional beam antenna and the parity data using a multi-beam or wide beam antenna.

3. A device according to claim 1, further comprising:
an encoder for encoding K blocks comprising first and second data into an encoded data unit comprising N encoded blocks, where N>K, using an error correction code having a minimum distance d;
wherein the error correction code is a systematic code causing the N encoded blocks of the encoded data unit to comprise the K data blocks of the data unit and N−K parity blocks generated from the encoding of the data unit.

4. A device for transmitting a data unit of K data blocks over a plurality of transmission paths of a wireless communication system, comprising:
an encoder for encoding the data unit into an encoded data unit comprising N encoded blocks, where N>K, using an error correction code having a minimum distance d; and
a wireless transmitter for transmitting the N encoded blocks of the encoded data unit over a set of N_{P} transmission paths, where N_{P}≧2, wherein the wireless transmitter is controlled to transmit at least N−d+1 different encoded blocks over at least one subset of N_{P}−M transmission paths, where M is a positive integer smaller than N_{P},
wherein the error correction code is a systematic code causing the N encoded blocks of the encoded data unit to comprise the K data blocks of the data unit and N−K parity blocks generated from the encoding of the data unit, and
wherein the number K of data blocks forming the data unit is chosen to be equal to the number N_{P} of transmission paths and wherein the transmission module is further configured to transmit different data blocks over different transmission paths of the set of N_{P} transmission paths using a directional beam antenna, and to transmit one given parity block over all the N_{P} transmission paths using a multi-beam or wide beam antenna.

5. A device according to claim 4, wherein the transmission module is configured to transmit the at least N−d+1 different encoded blocks over any subset of N_{P}−M transmission paths.

6. A device according to claim 4, wherein the error correction code is a maximum separable code with a minimum distance d=N−K+1, the number of different encoded blocks to be transmitted over the at least one subset of N_{P}−M transmission paths being at least equal to K.

7. A device according to claim 4, wherein a plurality of communication channels are defined in the wireless network for transporting the encoded blocks to be transmitted, different communication channels correspond to different transmission time slots and/or different transmission paths.

8. A method of transmitting a data unit of K data blocks over a plurality of transmission paths of a wireless communication system, comprising the steps of:
encoding the data unit into an encoded data unit comprising N encoded blocks, with N>K, using an error correction code having a minimum distance d; and
transmitting the N blocks of the encoded data unit over a set of N_{P} transmission paths, where N_{P}≧2, wherein at least N−d+1 different encoded blocks are transmitted over at least one subset of N_{P}−M transmission paths where M is a positive integer smaller than N_{P},
wherein the error correction code is a systematic code causing the N encoded blocks of the encoded data unit to comprise the K data blocks of the data unit and N−K parity blocks generated from the encoding of the data unit, and
wherein the number K of data blocks forming the data unit is chosen to be equal to the number N_{P} of transmission paths and wherein different data blocks are transmitted over different transmission paths of the set of N_{P} transmission paths using a directional beam antenna, and one given parity block is transmitted over all the N_{P} transmission paths using a multi-beam or wide beam antenna.

9. A method according to claim 8, wherein the at least N−d+1 different encoded blocks are transmitted over any subset of N_{P}−M transmission paths.

10. A method according claim 8, wherein the error correction code is a maximum separable code with a minimum distance d=N−K+1, the number of different encoded blocks to be transmitted over at least one subset of N_{P}−M transmission paths being at least equal to K.

11. A method according to claim 8, wherein a plurality of communication channels are defined in the wireless network for transporting the blocks to be transmitted, different communication channels correspond to different transmission time slots and/or different transmission paths.

12. A wireless communication system comprising:
an encoder for encoding the data unit into an encoded data unit comprising N encoded blocks, with N>K, using an error correction code having a minimum distance d;
a wireless transmitter for transmitting the N encoded blocks of the encoded data unit over a set of N_{P} transmission paths, where N_{P}≧2, wherein the wireless transmitter is configured to transmit at least N−d+1 different encoded blocks over at least one subset of N_{P}−M transmission paths where M is a positive integer smaller than N_{P};
wherein the error correction code is a systematic code causing the N encoded blocks of the encoded data unit to comprise the K data blocks of the data unit and N−K parity blocks generated from the encoding of the data unit, and
wherein the number K of data blocks forming the data unit is chosen to be equal to the number N_{P} of transmission paths and wherein the transmission module is further configured to transmit different data blocks over different transmission paths of the set of N_{P} transmission paths using a directional beam antenna, and to transmit one given parity block over all the N_{P} transmission paths using a multi-beam or wide beam antenna;
said communication system further comprising a wireless receiver configured to receive the encoded blocks of the encoded data unit via the set of at least two transmission paths N_{P}; and
a decoder for decoding a unit formed by the received encoded blocks to recover the original data unit.
